(19) United States
(12) Patent Application Publication
(10) Pub. No.: US 2025/0079708 A1
(43) Pub. Date: Mar. 6, 2025

(54) FREQUENCY MODULATION ANTENNA AND ANTENNA DEVICE

(71) Applicant: Wistron NeWeb Corporation, Hsinchu (TW)

(72) Inventors: Tzu-Min WU, Hsinchu (TW); Yu-Hsin YE, Hsinchu (TW); Kuang-Yuan KU, Hsinchu (TW); Kuo-Jen LAI, Hsinchu (TW)

(21) Appl. No.: 18/679,939

(22) Filed: May 31, 2024

(30) Foreign Application Priority Data
Sep. 5, 2023 (TW) 112133614

(51) Int. Cl. H01Q 7/00; H01Q 1/32; H01Q 1/42

(52) U.S. Cl. CPC H01Q 7/005; H01Q 1/3275; H01Q 1/42

(57) ABSTRACT

A frequency modulation antenna and an antenna device are proposed. The antenna device has an accommodating space, and the frequency modulation antenna is in the accommodating space and includes a main antenna structure and a first extending antenna structure. The main antenna structure includes a main substrate and a main loop radiator. The main substrate has a plane. The main loop radiator is disposed on the plane and has a first end and a second end in which the first end is coupled to a feeding point. The first extending antenna structure is vertically disposed on the plane and electrically connected to the second end. Therefore, the size of the frequency modulation antenna can be reduced and the performance of the frequency modulation antenna can be improved.

### RELATED APPLICATIONS

This application claims the benefit of priority to Taiwan Patent Application Serial No. 112133614, filed on Sep. 5, 2023. The entire content of the above identified application is incorporated herein by reference.

### BACKGROUND

### Technical Field

The present disclosure relates to a frequency modulation antenna and an antenna device, in particular to a frequency modulation antenna and an antenna device that can increase the radiation path and maintain a small size.

### Description of Related Art

With the development of the Internet of Vehicles (IoV), the integration of wireless communication and positioning technologies within vehicles is constantly increasing. This includes technologies such as in-vehicle hotspots (Wi-Fi), bluetooth, cellular communication, vehicle-to-vehicle communication, and global navigation satellite system (GNSS). Wireless communication devices such as digital televisions, car audio systems, and radio receivers are commonly installed in vehicles. The aforementioned wireless communication technologies and devices rely on in-vehicle antennas for receiving or transmitting wireless signals, enabling applications such as distance measurement and information exchange.

Existing in-vehicle frequency modulation (FM) antennas are primarily constructed using spiral coils. These antennas not only have larger dimensions and narrower bandwidth but also result in cumbersome and inconvenient installations when occupying a certain volume and space. Consequently, there is currently a lack of small-sized and high-performance in-vehicle antennas in the market. Therefore, industry participants are actively seeking solutions to address this issue.

### SUMMARY

According to an embodiment of the present disclosure, a frequency modulation antenna is provided, which includes a main antenna structure and a first extending antenna structure. The main antenna structure includes a main substrate and a main loop radiator. The main substrate has a plane. The main loop radiator is disposed on the plane and has a first end and a second end. The first end is coupled to a feeding point. The first extending antenna structure is vertically disposed on the plane and is electrically connected to the second end.

According to another embodiment of the present disclosure, an antenna device is provided, which includes a shell, an extending radiation structure, and a frequency modulation antenna. The shell includes a base and a radome. The radome is disposed on the base and has an accommodating space. The extending radiation structure is disposed on the radome. The frequency modulation antenna is in the accommodating space and includes a main antenna structure and a first extending antenna structure. The main antenna structure includes a main substrate and a main loop radiator. The main substrate has a plane and is disposed on the base. The main loop radiator is disposed on the plane and has a first end and a second end. The first end is coupled to a feeding point. The first extending antenna structure is vertically disposed on the plane.

The first extending antenna structure is electrically connected between the second end and the extending radiation structure.

### BRIEF DESCRIPTION OF THE DRAWINGS

The present disclosure can be more fully understood by reading the following detailed description of the embodiment, with reference made to the accompanying drawings as follows:

FIG. 1 is a perspective view of a frequency modulation antenna according to a first example of a first embodiment of the present disclosure.

FIG. 2 is a top view of a main antenna structure of the frequency modulation antenna of FIG. 1 according to the first example of the first embodiment.

FIG. 3 is an exploded view of a frequency modulation antenna according to a second example of the first embodiment of the present disclosure.

FIG. 4 is a perspective view of a frequency modulation antenna according to a third example of the first embodiment of the present disclosure.

FIG. 5 is an exploded view of a frequency modulation antenna according to a fourth example of the first embodiment of the present disclosure.

FIG. 6A is a perspective view of an antenna device according to a first example of a second embodiment of the present disclosure.

FIG. 6B is a cross-sectional view of the antenna device of FIG. 6A according to the first example of the second embodiment.

FIG. 7 is a cross-sectional view of an antenna device according to a second example of the second embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein.

Numbering terms such as “first,” “second” or “third” can be used to describe various components, signals or the like, which are for distinguishing one component/signal from another one only, and are not intended to, nor should be construed to impose any substantive limitations on the components, signals or the like.

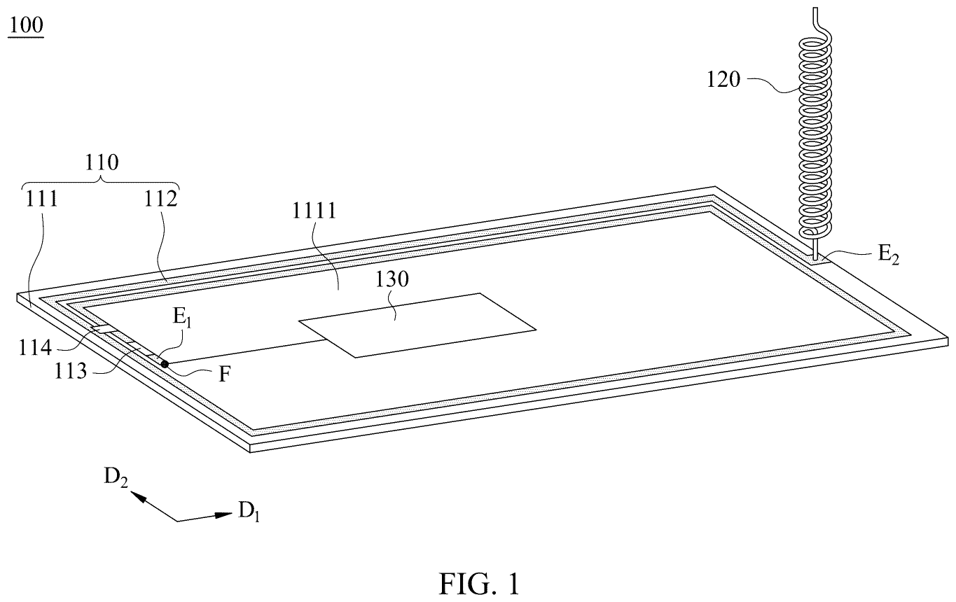

Referring to FIG. 1. FIG. 1 is a perspective view of a frequency modulation antenna 100 according to a first example of a first embodiment of the present disclosure. As shown in FIG. 1, the frequency modulation antenna 100 includes a main antenna structure 110 and a first extending antenna structure 120. The main antenna structure 110 includes a main substrate 111 and a main loop radiator 112. The main substrate 111 may be a plane substrate, such as a system main board of a communication equipment or an electronic device, a printed circuit board (PCB), a flame retardant 4 (FR4) substrate, or a flexible printed circuit board (FPCB). The main substrate 111 also has a plane 1111. The main loop radiator 112 may be a loop structure made of metal materials (e.g., copper, nickel, gold, or alloys of the metals as mentioned) and may be formed through laser direct structuring (LDS), electroplating, or 3D printing technology, and is installed/manufactured on the plane 1111. The main loop radiator 112 has a first end E₁ and a second end E₂. The first end E₁ is coupled to a feeding point F and may serves as a signal receiving end. The first extending antenna structure 120 is vertically disposed on the plane 1111 and is electrically connected to the second end E₂ of the main loop radiator 112. Therefore, the main loop radiator 112 can be coupled to the first extending antenna structure 120 via the second end E₂.

Specifically, the frequency modulation antenna 100 may be a vehicle antenna applied in a frequency modulation (FM) frequency band or FM operational frequency ranges. The main antenna structure 110 may be a loop antenna. The main loop radiator 112 appears to be a hollow rectangle. The first extending antenna structure 120 may be a helical antenna. Therefore, the frequency modulation antenna 100 of the present disclosure extends the radiation path of the antenna through a structural configuration in which the first extending antenna structure 120 is vertically disposed on the main antenna structure 110, which not only reduces the overall size of the frequency modulation antenna 100, but also increases the bandwidth of the frequency modulation antenna 100. It is noted that the radiation path refers to a path length when a signal is transmitted on the main loop radiator 112 and the first extending antenna structure 120.

In addition, the frequency modulation antenna 100 may further include a signal enhancing circuit 130, which may be a signal amplifier in a signal source (e.g., a radio frequency module, which is not shown herein). The signal enhancing circuit 130 is disposed on the main substrate 111 and is within the hollow rectangle formed by the main loop radiator 112. The signal enhancing circuit 130 is electrically connected to the first end E₁ of the main loop radiator 112, and a connection point between the signal enhancing circuit 130 and the first end E₁ is a feeding point F. The signal source may be used to excite the main loop radiator 112, so that the main loop radiator 112 is operated in a first frequency band. The main loop radiator 112 is coupled to the first extending antenna structure 120, so that the first extending antenna structure 120 is operated in a second frequency band. Therefore, the combination of the main loop radiator 112 and the signal enhancing circuit 130 enables the frequency modulation antenna 100 to function as an active FM antenna.

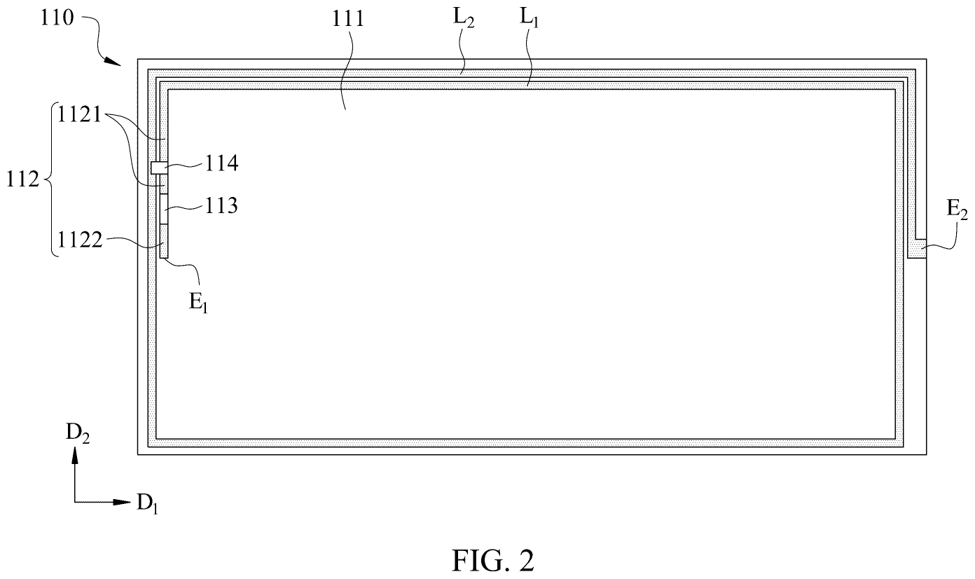

Referring to FIG. 1 and FIG. 2. FIG. 2 is a top view of the main antenna structure 110 of the frequency modulation antenna 100 of FIG. 1 according to the first example of the first embodiment. As shown in FIG. 1 and FIG. 2, the first end E₁ and the second end E₂ of the main loop radiator 112 are aligned with each other in a first direction D₁, and are extended along a second direction D₂. The first direction D₁ is perpendicular to the second direction D₂.

The main loop radiator 112 may include a radiating segment 1121 and a feeding segment 1122 having the first end E₁. The radiating segment 1121 is coupled to the feeding segment 1122 and includes a plurality of loops L₁, L₂ formed by outward extension of the feeding segment 1122. In the first example, the number of loops of the main loop radiator 112 is two. However, in other examples, the number of loops may depend on the frequency band to be applied. Therefore, the present disclosure is not limited to the number of loops.

The main antenna structure 110 may further include an inductive element 113. The inductive element 113 is on the main substrate 111 and is adjacent to the first end E₁. The inductive element 113 is connected in series between the radiating segment 1121 and the feeding segment 1122. The frequency modulation antenna 100 of the first example is operated in an operational frequency range, and the operational frequency range is between 88 MHz and 108 MHz. In other examples, when the main antenna structure of another FM antenna is not configured with the inductive element 113, its operational frequency range is between 160 MHz and 170 MHz. Thus, the frequency modulation antenna 100 of the first example can shift the operational frequency range (160 MHz-170 MHz) without inductive element 113 as mentioned to the operational frequency range (88 MHz-108 MHz) by connecting the inductive element 113 in series between the radiating segment 1121 and the feeding segment 1122. Therefore, when the antenna space is limited (that is, when the area range that the main loop radiator 112 can use based on the plane 1111 is small, resulting in insufficient paths for the main loop radiator 112), the frequency modulation antenna 100 can still achieve frequency offset by configuring the inductive element 113 with different inductance values and is applied to a specific FM frequency band.

The main antenna structure 110 may further include a capacitive element 114 on the main substrate 111. The capacitive element 114 is spaced apart from the inductive element 113. The capacitive element 114 is adjacent to the first end E₁ of the feeding segment 1122, and is connected in parallel with the loops L₁, L₂. Therefore, the frequency modulation antenna 100 of the present disclosure can adjust the antenna matching by connecting the capacitive element 114 in parallel with the main loop radiator 112.

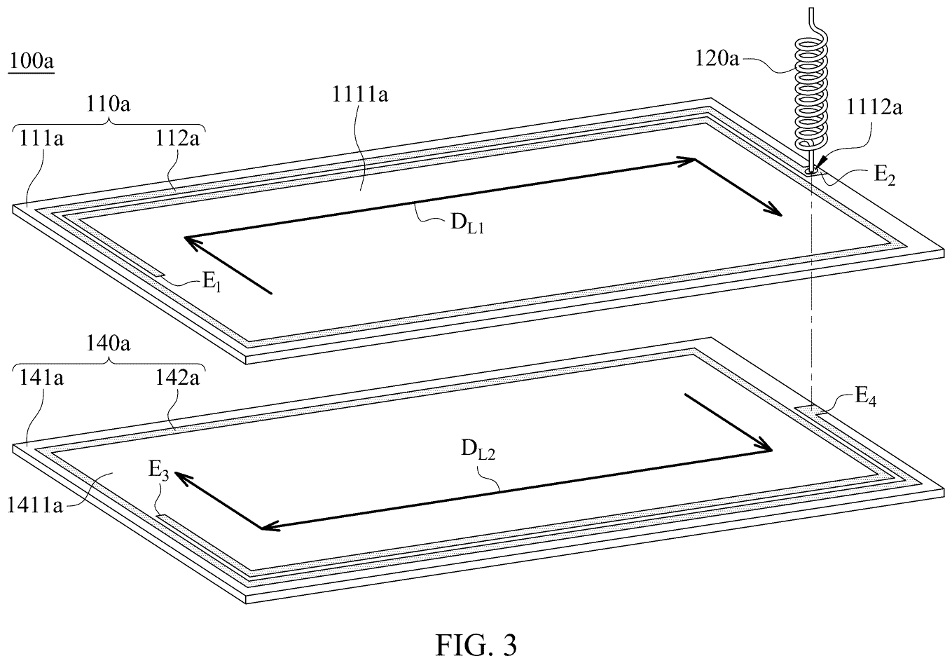

Referring to FIG. 3. FIG. 3 is an exploded view of a frequency modulation antenna 100a according to a second example of the first embodiment of the present disclosure. As shown in FIG. 3, the structure and configuration relationship between a main antenna structure 110a and a first extending antenna structure 120a of the frequency modulation antenna 100a are similar to the corresponding elements of the frequency modulation antenna 100 in the first example. The difference is that a main substrate 111a of the frequency modulation antenna 100a may include a through hole 1112a. The through hole 1112a penetrates through the main substrate 111a and is electrically connected to one end of the first extending antenna structure 120a and the second end E₂ of a main loop radiator 112a.

In addition, the frequency modulation antenna 100a may further include a second extending antenna structure 140a. The second extending antenna structure 140a is disposed opposite to the first extending antenna structure 120a based on the main substrate 111a. The second extending antenna structure 140a includes an auxiliary substrate 141a and an auxiliary loop radiator 142a. The auxiliary substrate 141a has a plane 1411a. The plane 1411a of the auxiliary substrate 141a and the plane 1111a of the main substrate 111a are disposed parallel to each other. The auxiliary loop radiator 142a is disposed on the plane 1411a of the auxiliary substrate 141a and has a first end E₃ and a second end E₄. The second end E₄ of the auxiliary loop radiator 142a is aligned with the second end E₂ of the main loop radiator 112a, and is electrically connected to one end of the first extending antenna structure 120a and the second end E₂ of the main loop radiator 112a via the through hole 1112a of the main substrate 111a.

Furthermore, there is a first loop direction D_{L1} from the first end E₁ of the main loop radiator 112a to the second end E₂ of the main loop radiator 112a. There is a second loop direction D_{L2} from the second end E₄ of the auxiliary loop radiator 142a to the first end E₃ of the auxiliary loop radiator 142a. The first loop direction D_{L1} and the second loop direction D_{L2} are in the same direction. That is, a current direction on the main loop radiator 112a is the same as a current direction on the auxiliary loop radiator 142a.

Thus, when the length of the single-layer loop path is insufficient, in addition to achieving the effect of extending the path by configuring the inductive element 113 of the first example, since the loop structure itself of the auxiliary loop radiator 142a has a certain inductance, the effect of increasing the inductance can also be achieved through the double-layer loop configuration provided in the second example. Furthermore, in addition to increasing the inductance by the double-layer loop configuration, the double-layer loop configuration also has a radiation path provided by the first extending antenna structure 120a upward from the second end E₂ of the main loop radiator 112a, and a radiation path provided by the auxiliary loop radiator 142a downward from the second end E₂. Therefore, the two radiation paths as mentioned can resonate to generate another operational frequency range, thereby increasing the bandwidth.

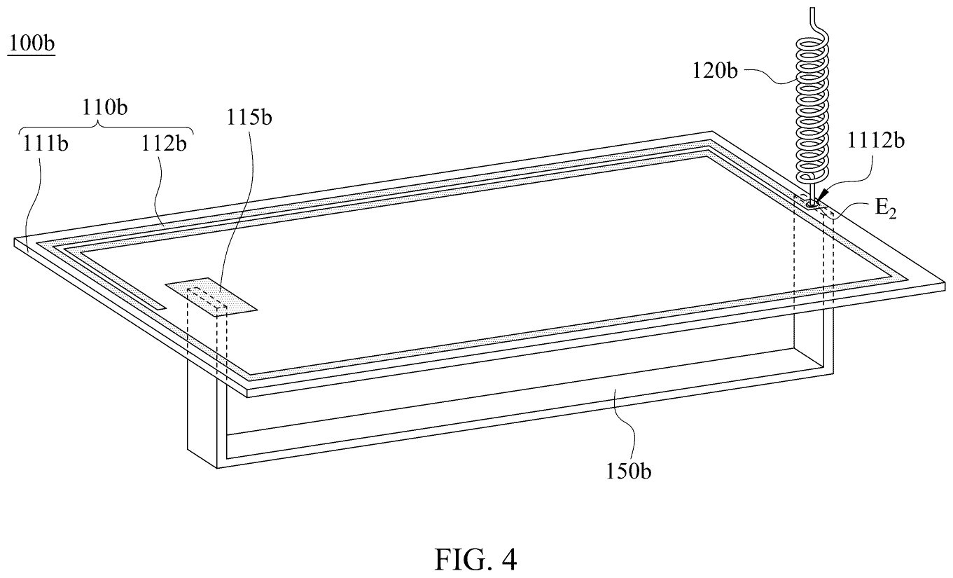

Referring to FIG. 4. FIG. 4 is a perspective view of a frequency modulation antenna 100b according to a third example of the first embodiment of the present disclosure. As shown in FIG. 4, the structure and configuration relationship between a main antenna structure 110b and a first extending antenna structure 120b of the frequency modulation antenna 100b are similar to the corresponding elements of the frequency modulation antenna 100a in the second example. The difference is that a main substrate 111b of the frequency modulation antenna 100b may include a contact pad 115b.

In addition, the frequency modulation antenna 100b may further include a metal element 150b. One end of the metal element 150b is electrically connected to one end of the first extending antenna structure 120b and the second end E₂ of the main loop radiator 112b via a through hole 1112b of the main substrate 111b. Another end of the metal element 150b is electrically connected to the contact pad 115b of the main substrate 111b.

Specifically, when active circuits or other electronic circuits need to be configured around the lower layer of the frequency modulation antenna 100a of the second example, there will be insufficient space for the configuration of the second extending antenna structure 140a. Compared to the frequency modulation antenna 100a of the second example, the metal element 150b of the third example can be a U-shaped bracket. By replacing the lower loop structure with the metal element 150b, the frequency modulation antenna 100b can use the U-shaped bracket to avoid the location of other circuits. Furthermore, the metal element 150b can not only increase the radiation path of the main loop radiator 112b to achieve frequency offset, but can also resonate with the radiation path provided by the first extending antenna structure 120b to generate another operational frequency range, thereby increasing the bandwidth. The metal element 150b of the present disclosure is not limited to U shape.

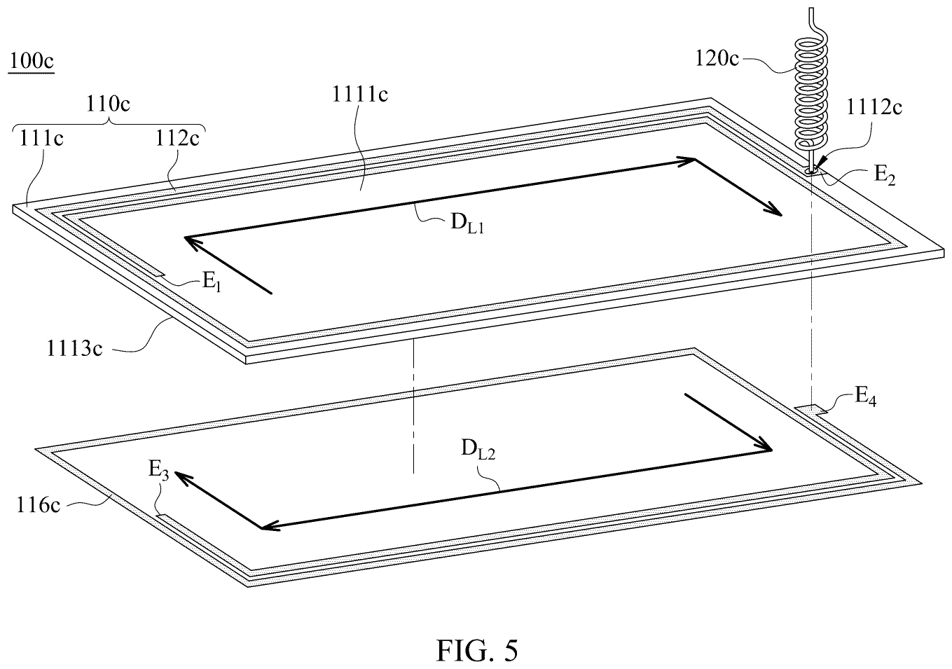

Referring to FIG. 5. FIG. 5 is an exploded view of a frequency modulation antenna 100c according to a fourth example of the first embodiment of the present disclosure. As shown in FIG. 5, the structure and configuration relationship between a main antenna structure 110c and a first extending antenna structure 120c of the frequency modulation antenna 100c are similar to the corresponding elements of the frequency modulation antenna 100a in the second example. The difference is that a main substrate 111c of the frequency modulation antenna 100c may include a through hole 1112c. The through hole 1112c penetrates through the main substrate 111c and is electrically connected to one end of the first extending antenna structure 120c and the second end E₂ of a main loop radiator 112c. The main substrate 111c may further has another plane 1113c (i.e., the back surface of the main substrate 111c) disposed parallel to a plane 1111c (i.e., the front surface of the main substrate 111c).

In addition, the main antenna structure 110c may further include an auxiliary loop radiator 116c. The auxiliary loop radiator 116c is disposed on the another plane 1113c, and has a first end E₃ and a second end E₄. The second end E₄ of the auxiliary loop radiator 116c is aligned with the second end E₂ of the main loop radiator 112c, and is electrically connected to one end of the first extending antenna structure 120c and the second end E₂ of the main loop radiator 112c via the through hole 1112c of the main substrate 111c.

Furthermore, there is a first loop direction D_{L1} from the first end E₁ of the main loop radiator 112c to the second end E₂ of the main loop radiator 112c. There is a second loop direction D_{L2} from the second end E₄ of the auxiliary loop radiator 116c to the first end E₃ of the auxiliary loop radiator 116c. The first loop direction D_{L1} and the second loop direction D_{L2} are in the same direction. That is, a current direction on the main loop radiator 112c is the same as a current direction of the auxiliary loop radiator 116c.

Thus, when the length of the main loop radiator 112c is insufficient, in addition to achieving the effect of extending the path by configuring the inductive element 113 of the first example, the second extending antenna structure 140a of the second example, or the metal element 150b of the third example, since the loop structure of the auxiliary loop radiator 116c has a certain inductance, disposing the auxiliary loop radiator 116c directly on the another plane 1113c of the main substrate 111c can not only increase the overall inductance of the main antenna structure 110c, but can also significantly reduce the manufacturing cost.

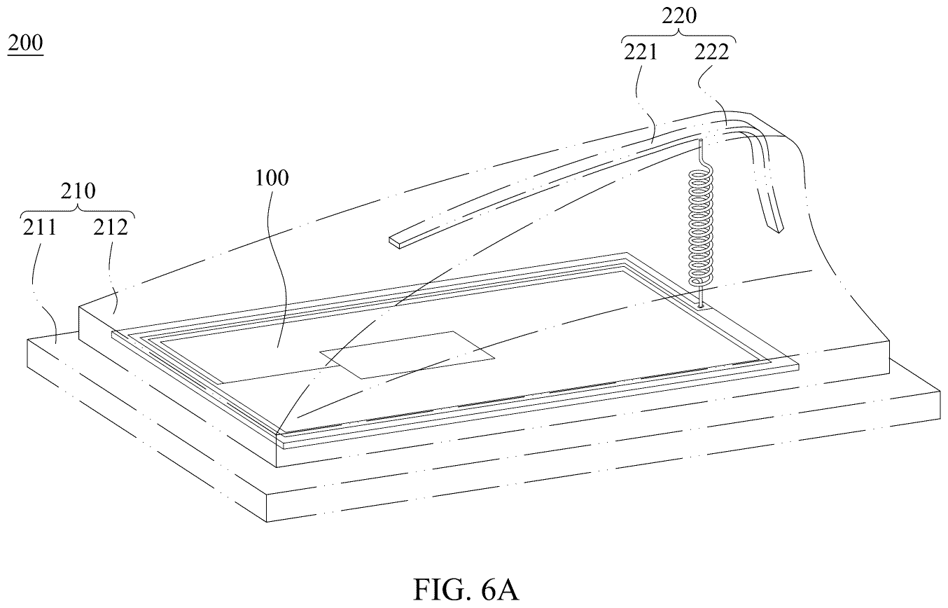

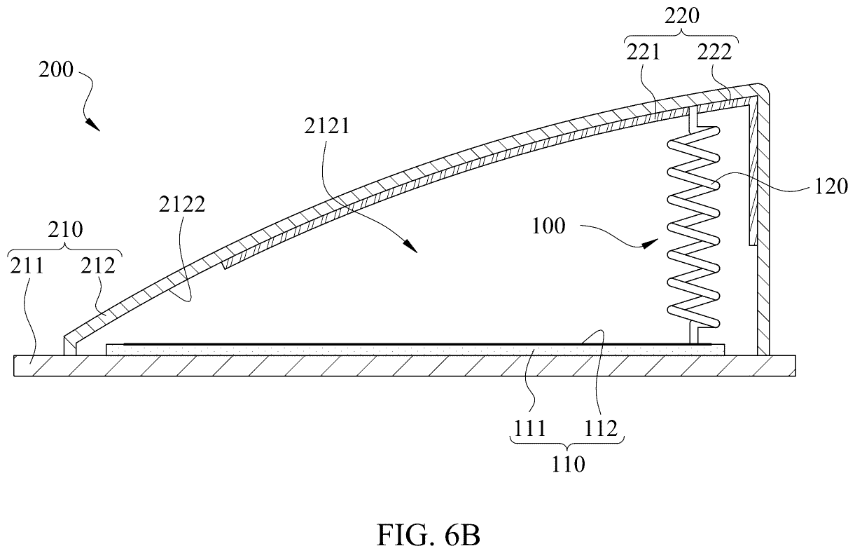

Referring to FIGS. 1, 6A, and 6B. FIG. 6A is a perspective view of an antenna device 200 according to a first example of a second embodiment of the present disclosure. FIG. 6B is a cross-sectional view of the antenna device 200 of FIG. 6A according to the first example of the second embodiment. As shown in FIG. 6A and FIG. 6B, the antenna device 200 includes the frequency modulation antenna 100 of FIG. 1, a shell 210, and an extending radiation structure 220. The shell 210 includes a base 211 and a radome 212. The radome 212 is disposed on the base 211 and has an accommodating space 2121. The extending radiation structure 220 is disposed on the radome 212. The frequency modulation antenna 100 is in the accommodating space 2121. The main substrate 111 of the main antenna structure 110 is disposed on the base 211. The first extending antenna structure 120 is electrically connected between the second end E₂ of the main loop radiator 112 and the extending radiation structure 220.

Specifically, the antenna device 200 can be a vehicle antenna device applied in FM frequency band or FM operational frequency ranges. The shell 210 can be a shark fin shell, and its material can be LDS plastic. The radome 212 can further has an internal surface 2122. The extending radiation structure 220 can be a wire/line made of metal materials (e.g., copper, nickel, gold, or alloys of the metals as mentioned) and is disposed/manufactured on the internal surface 2122. Specifically, the extending radiation structure 220 may include two radiators 221, 222. The two radiators 221, 222 are disposed and spaced apart on the internal surface 2122, and are electrically connected to the first extending antenna structure 120 of the frequency modulation antenna 100. When the shell 210 is installed on the metal vehicle shell, the frequency modulation antenna 100 can extend the radiation path by the extending radiation structure 220 disposed on the radome 212, so that the antenna radiation can be away from the metal vehicle shell to avoid the signal from being interfered by the metal vehicle shell, and achieving superior antenna performance. In other examples, the extending radiation structure can also be a single metal line.

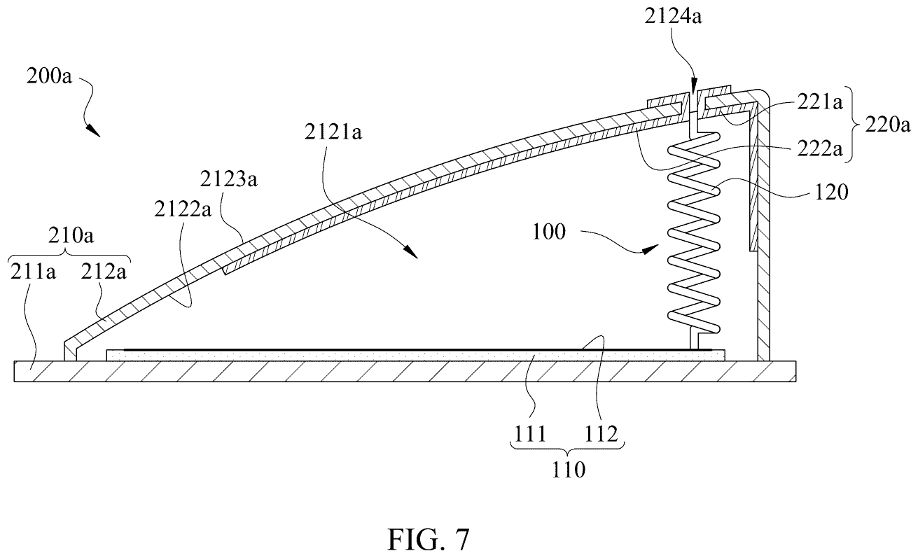

Referring to FIG. 1 and FIG. 7. FIG. 7 is a cross-sectional view of an antenna device 200a according to a second example of the second embodiment of the present disclosure. As shown in FIG. 7, the antenna device 200a includes the frequency modulation antenna 100 of FIG. 1, a shell 210a, and an extending radiation structure 220a. The shell 210a includes a base 211a and a radome 212a. The radome 212a is disposed on the base 211a and has an accommodating space 2121a. The extending radiation structure 220a is disposed on the radome 212a. The frequency modulation antenna 100 is in the accommodating space 2121a, and the main substrate 111 of the main antenna structure 110 is disposed on the base 211a.

Furthermore, the radome 212a may further has an internal surface 2122a and an outer surface 2123a, and include a via 2124a penetrating through the internal surface 2122a and the outer surface 2123a. The via 2124a can be made by LDS laser engraving. The extending radiation structure 220a may include a first radiator 221a and a second radiator 222a. The first radiator 221a is disposed on the internal surface 2122a and the outer surface 2123a via the via 2124a. The second radiator 222a is disposed opposite to the first radiator 221a based on the via 2124a. That is, the second radiator 222a is disposed on the internal surface 2122a and the outer surface 2123a via the via 2124a. One end of the first extending antenna structure 120 is electrically connected between the first radiator 221a and the second radiator 222a. Therefore, the antenna device 200a of the present disclosure uses the configuration of the via 2124a, so that the internal main loop radiator 112 can not only extend the radiation path through the first extending antenna structure 120, but can be also additionally connected to the first radiator 221a and the second radiator 222a to achieve the function of configuring multi-path. In addition, compared to the antenna device 200 of the first example, one end of the overall antenna path of the antenna device 200a of the second example is further away from the metal vehicle shell, so the antenna bandwidth and efficiency are better.

In summary, the present disclosure has the following advantages. First, extending the radiation path through a structural configuration that the first extending antenna structure is vertically disposed on the main antenna structure, which not only reduces the size of the antenna but also increases the bandwidth of the antenna. Second, when the antenna space is limited, frequency offset can still be achieved by configuring inductive elements with different inductance values. Third, by connecting a capacitive element in parallel with the main loop radiator, the antenna matching is adjusted. Fourth, through the configuration of double-layer loops, the inductance is achieved and the bandwidth is increased. Fifth, the configuration of a metal element is used to avoid the location of other circuits, thereby improving the application level of the frequency modulation antenna. Sixth, the radiation path is extended by the extending radiation structure provided on the radome, so that the antenna radiation is away from the metal vehicle shell, thereby avoiding signal interference.

The foregoing description of the disclosure has been presented only for the purposes of illustration and description option of the exemplary embodiments and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A frequency modulation antenna, comprising:
a main antenna structure, comprising:
a main substrate having a plane; and
a main loop radiator disposed on the plane and having a first end and a second end, wherein the first end is coupled to a feeding point; and
a first extending antenna structure vertically disposed on the plane and electrically connected to the second end.

2. The frequency modulation antenna according to claim 1, wherein the main antenna structure is a loop antenna, the main loop radiator is a hollow rectangle, and the first extending antenna structure is a helical antenna.

3. The frequency modulation antenna according to claim 1, wherein the first end and the second end are aligned with each other in a first direction and extended along a second direction, and the first direction is perpendicular to the second direction.

4. The frequency modulation antenna according to claim 1, wherein the main antenna structure further comprises:
an inductive element on the main substrate and adjacent to the first end;
wherein the main loop radiator comprises a radiating segment and a feeding segment having the first end, and the inductive element is connected in series between the radiating segment and the feeding segment.

5. The frequency modulation antenna according to claim 1, wherein the main antenna structure further comprises:
a capacitive element on the main substrate and adjacent to the first end;
wherein the main loop radiator comprises a radiating segment and a feeding segment having the first end, the radiating segment is coupled to the feeding segment and comprises a plurality of loops formed by outward extension of the feeding segment, and the capacitive element is connected in parallel with two of the loops.

6. The frequency modulation antenna according to claim 1, further comprising:
a signal enhancing circuit disposed on the main substrate and inside the main loop radiator, wherein the signal enhancing circuit is electrically connected to the first end of the main loop radiator.

7. The frequency modulation antenna according to claim 1, further comprising:
a second extending antenna structure disposed opposite to the first extending antenna structure based on the main substrate, and comprising:
an auxiliary substrate having a plane, wherein the plane of the auxiliary substrate and the plane of the main substrate are disposed parallel to each other; and
an auxiliary loop radiator disposed on the plane of the auxiliary substrate and having a first end and a second end, wherein the second end of the auxiliary loop radiator is electrically connected to and aligned with the second end of the main loop radiator via a through hole of the main substrate.

8. The frequency modulation antenna according to claim 1, wherein the main substrate further has another plane parallel to the plane, and the main antenna structure further comprises:
an auxiliary loop radiator disposed on the another plane and having a first end and a second end, wherein the second end of the auxiliary loop radiator is electrically connected to and aligned with the second end of the main loop radiator via a through hole of the main substrate.

9. The frequency modulation antenna according to claim 8, wherein a first loop direction from the first end of the main loop radiator to the second end of the main loop radiator and a second loop direction from the second end of the auxiliary loop radiator to the first end of the auxiliary loop radiator are in a same direction.

10. The frequency modulation antenna according to claim 1, further comprising:
a metal element, wherein one end of the metal element is electrically connected to the second end of the main loop radiator via a through hole of the main substrate, and another end of the metal element is electrically connected to a contact pad of the main substrate.

11. The frequency modulation antenna according to claim 1, wherein the frequency modulation antenna is operated in an operational frequency range, and the operational frequency range is between 88 MHz and 108 MHz.

12. An antenna device, comprising:
a shell, comprising:
a base; and
a radome disposed on the base and having an accommodating space;
an extending radiation structure disposed on the radome; and
a frequency modulation antenna in the accommodating space, and comprising:
a main antenna structure, comprising:
a main substrate having a plane and disposed on the base; and
a main loop radiator disposed on the plane and having a first end and a second end, wherein the first end is coupled to a feeding point; and
a first extending antenna structure vertically disposed on the plane and electrically connected between the second end and the extending radiation structure.

13. The antenna device according to claim 12, wherein the radome further has an internal surface, the extending radiation structure comprises two radiators, the two radiators are disposed and spaced apart on the internal surface, and are electrically connected to the first extending antenna structure.

14. The antenna device according to claim 12, wherein the radome further has an internal surface and an outer surface, and comprises a via penetrating through the internal surface and the outer surface, and the extending radiation structure comprises:
a first radiator disposed on the internal surface and the outer surface via the via; and
a second radiator disposed opposite to the first radiator based on the via;
wherein one end of the first extending antenna structure is electrically connected between the first radiator and the second radiator.

15. The antenna device according to claim 12, wherein the main antenna structure further comprises:
an inductive element on the main substrate and adjacent to the first end;
wherein the main loop radiator comprises a radiating segment and a feeding segment having the first end, and the inductive element is connected in series between the radiating segment and the feeding segment.

16. The antenna device according to claim 12, wherein the main antenna structure further comprises:
a capacitive element on the main substrate and adjacent to the first end;
wherein the main loop radiator comprises a radiating segment and a feeding segment having the first end, the radiating segment is coupled to the feeding segment and comprises a plurality of loops formed by outward extension of the feeding segment, and the capacitive element is connected in parallel with two of the loops.

17. The antenna device according to claim 12, wherein the frequency modulation antenna further comprises:
a second extending antenna structure disposed opposite to the first extending antenna structure based on the main substrate, and comprising:
an auxiliary substrate having a plane, wherein the plane of the auxiliary substrate and the plane of the main substrate are disposed parallel to each other; and
an auxiliary loop radiator disposed on the plane of the auxiliary substrate and having a first end and a second end, wherein the second end of the auxiliary loop radiator is electrically connected to and aligned with the second end of the main loop radiator via a through hole of the main substrate.

18. The antenna device according to claim 12, wherein the main substrate further has another plane parallel to the plane, and the main antenna structure further comprises:
an auxiliary loop radiator disposed on the another plane and having a first end and a second end, wherein the second end of the auxiliary loop radiator is electrically connected to and aligned with the second end of the main loop radiator via a through hole of the main substrate.

19. The antenna device according to claim 18, wherein a first loop direction from the first end of the main loop radiator to the second end of the main loop radiator and a second loop direction from the second end of the auxiliary loop radiator to the first end of the auxiliary loop radiator are in a same direction.

20. The antenna device according to claim 12, wherein the frequency modulation antenna further comprises:
a metal element, wherein one end of the metal element is electrically connected to the second end of the main loop radiator via a through hole of the main substrate, and another end of the metal element is electrically connected to a contact pad of the main substrate.
